(19) United States
(12) Patent Application Publication
(10) Pub. No.: US 2007/0067239 A1
(43) Pub. Date: Mar. 22, 2007

(54) Method and Apparatus for Transferring Financial Information

(75) Inventors: Sanjeev Dheer, Scarsdale, NY (US); Gautam Sinha, San Ramon, CA (US); Balraj Suneja, Norwalk, CT (US); Manish Vrishaketu, San Jose, CA (US); Jeremy N. Sokolic, New York, NY (US)

Correspondence Address: LEE & HAYES, PLLC, 421 W. RIVERSIDE AVE, STE 500, SPOKANE, WA, 99201, US

(73) Assignee: CashEdge, Inc., New York, NY (US)

(21) Appl. No.: 11/465,007

(22) Filed: Aug. 16, 2006

Related U.S. Application Data
(60) Provisional application No. 60/718,493, filed on Sep. 19, 2005.

(51) Int. Cl. G06Q 40/00

(52) U.S. Cl. 705/40

(57) ABSTRACT

A request is received to transfer bill payment data from a first account associated with a first entity to a second account associated with a second entity. Bill payment information is retrieved from the first entity. The second account is accessed and the bill payment data is established at the second entity.

### RELATED APPLICATIONS

This application claims the benefit of U.S. Provisional Application No. 60/718,493, filed Sep. 19, 2005, the disclosure of which is incorporated by reference herein.

### TECHNICAL FIELD

The present invention relates to the handling of data and, more particularly, to the transferring of bill payment information between two or more entities.

### BACKGROUND

Customers of financial institutions (including individual customers, businesses, and other entities) typically maintain multiple financial accounts at one or more financial institutions. Financial institutions include, for example, banks, savings and loans, credit unions, mortgage companies, lending companies, and stock brokers. These financial accounts include asset accounts (such as savings accounts, checking accounts, certificates of deposit (CDs), mutual funds, bonds, and equities) and debt accounts (such as credit card accounts, mortgage accounts, home equity loans, overdraft protection, and other types of loans).

Many financial institutions now offer automated bill payment services and online bill payment services for their customers. Automated bill payment services allow a customer to automatically send a payment to a particular payee every month, thereby eliminating the need for the customer to manually write a check or otherwise pay the payee. Online bill payment services allow customers to send payments to payees via an online interface, such as through the financial institution's web site. These online bill payment services allow customers to quickly schedule the payment of one or more bills to one or more payees online without writing checks, mailing checks, and the like.

When using a typical automated bill payment service or online bill payment service, the customer must initially configure the service by providing information about the payee, such as the payee mailing address, payment amount, payment due date, customer's account number with payee, and the like. Once such information is configured, the service typically maintains that information for use in processing future payments. However, if a customer wants to “transfer” the automated bill payment function or the online bill payment function to a new financial institution, the customer is generally required to reconfigure the service at the new financial institution by providing the same payee information provided to the previous financial institution. Such reconfiguration of the automated bill payment service or the online bill payment service is tedious and potentially time-consuming for the customer.

The systems and methods described herein allow a customer to transfer payee and payment data or online payee and payment data to a new entity, such as a financial institution, without having to fully configure the payee and payment data at the new entity.

### BRIEF DESCRIPTION OF THE DRAWINGS

FIG. 1 illustrates an example network environment in which various servers, computing devices, and financial management systems exchange data across a network, such as the Internet.

FIG. 2 illustrates an example of the interaction between a particular pair of financial institution servers, a financial management system, and a client computer.

FIG. 3 is a block diagram showing pertinent components of a computer in accordance with the present invention.

FIG. 4 is a block diagram showing example components and modules of a financial management system.

FIG. 5 is a flow diagram illustrating a procedure for transferring bill payment information from a first financial institution to a second financial institution.

FIG. 6 illustrates an example display of various bill payment information.

### DETAILED DESCRIPTION

The systems and methods described herein allow a user (also referred to as an “account holder” or a “customer”) to transfer automated bill payment information and/or online bill payment information from a first entity to a second entity (e.g., from a first financial institution to a second financial institution). The described systems and methods automate many of the tasks required to transfer automated bill payment information and/or online bill payment information between entities. Further, the systems and methods allow users to modify bill payment information and/or online bill payment information before that information is provided to the new entity.

The specific examples discussed herein are directed toward automated bill payment information and online bill payment information that is exchanged between two financial institutions. However, in alternate embodiments, any type of information may be exchanged between any number of entities, which may include one or more financial institutions. Alternate types of accounts/data include cellular phone usage, automobile usage and service records, etc.

As used herein, the terms “account holder”, “customer”, “user”, and “client” are interchangeable. “Account holder” refers to any person having access to an account. A particular account may have multiple account holders (e.g., a joint checking account may include a husband and a wife as account holders or a corporate account may identify several corporate employees as account holders). Various financial account and financial institution examples are provided herein for purposes of explanation. However, it will be appreciated that the system and procedures described herein can be used with any type of asset account and any type of debt account. Example asset accounts include savings accounts, money market accounts, checking accounts (both interest-bearing and non-interest-bearing), certificates of deposit (CDs), mutual funds, bonds, and equities. Example debt accounts include credit card accounts, mortgage accounts, home equity loans, overdraft protection, margin accounts, personal loans, and other types of loans. Exemplary financial institutions include banks, savings and loans, credit unions, mortgage companies, mutual fund companies, lending companies, and stock brokers.

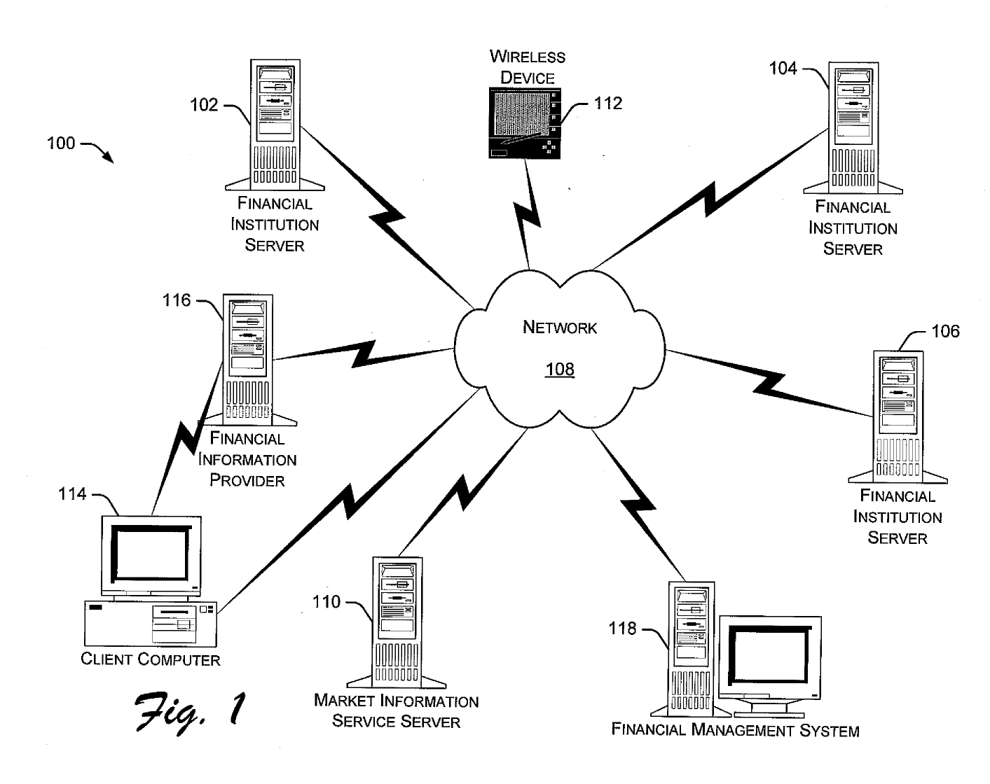

FIG. 1 illustrates an example network environment 100 in which various servers, computing devices, and financial management systems exchange data across a data communication network. The network environment of FIG. 1 includes multiple financial institution servers 102, 104, and 106 coupled to a data communication network 108, such as the Internet. A market information service server 110 and a financial management system 118 are also coupled to network 108. Additionally, a wireless device 112 and a client computer 114 are coupled to network 108. Wireless device 112 may be a personal digital assistant (PDA), a handheld or portable computer, a cellular phone, a pager, or any other device capable of communicating with other devices via any type of wireless connection. A financial information provider 116 is coupled to network 108 and client computer 114. Network 108 can be any type of data communication network using any communication protocol. Further, network 108 may include one or more sub-networks (not shown) which are interconnected with one another.

The communication links shown between network 108 and the various devices (102-106 and 110-118) shown in FIG. 1 can use any type of communication medium and any communication protocol. For example, one or more of the communication links shown in FIG. 1 may be wireless links (such as a radio frequency (RF) link or a microwave link) or wired links accessed via a network, a public telephone system, or another communication network. Wireless device 112 typically accesses network 108 via a wireless connection to another communication network that is coupled to network 108. Certain devices, such as servers, may be coupled to a local area network (LAN), which is coupled to network 108. Client computer 114 may access network 108 in different ways. First, client computer 114 may directly access network 108, for example, by using a modem to access a public telephone network (e.g., a public switched telephone network (PSTN)) that is coupled to network 108. Alternately, client computer 114 may access financial information provider 116, which establishes a connection to network 108. Financial information provider 116 may act as a “buffer” between network 108 and client computer 114, or may allow commands and data to simply pass-through between the network 108 and the client computer 114.

Each of the financial institution servers 102, 104, and 106 are typically associated with a particular financial institution and store data for that financial institution, such as customer account data. In an alternate embodiment, some data may be stored at a bill payment provider and/or an online payment provider. The market information service server 110 may represent one or more services that collect and report information regarding current financial market conditions. For example, a particular market information service may collect information from many financial institutions to generate a report identifying the average interest rates for savings, checking, or other accounts. The report may also identify fees charged for various services, including online bill payment services and automated payment services. Multiple market information service servers 110 may be coupled to network 108, each server providing a different type of market data.

Financial management system 118 performs various account-related functions for the benefit of users and/or financial institutions. Wireless device 112 and client computer 114 allow a user to access information via the network 108. For example, the user can access account information from one of the financial institution servers 102, 104, or 106, or send a request to initiate the transfer of bill payment information from one financial institution to another financial institution.

Although FIG. 1 illustrates financial management system 118 as a separate component, alternate embodiments may incorporate some or all of the functionality provided by financial management system 118 into one or more financial institution servers 102, 104, or 106.

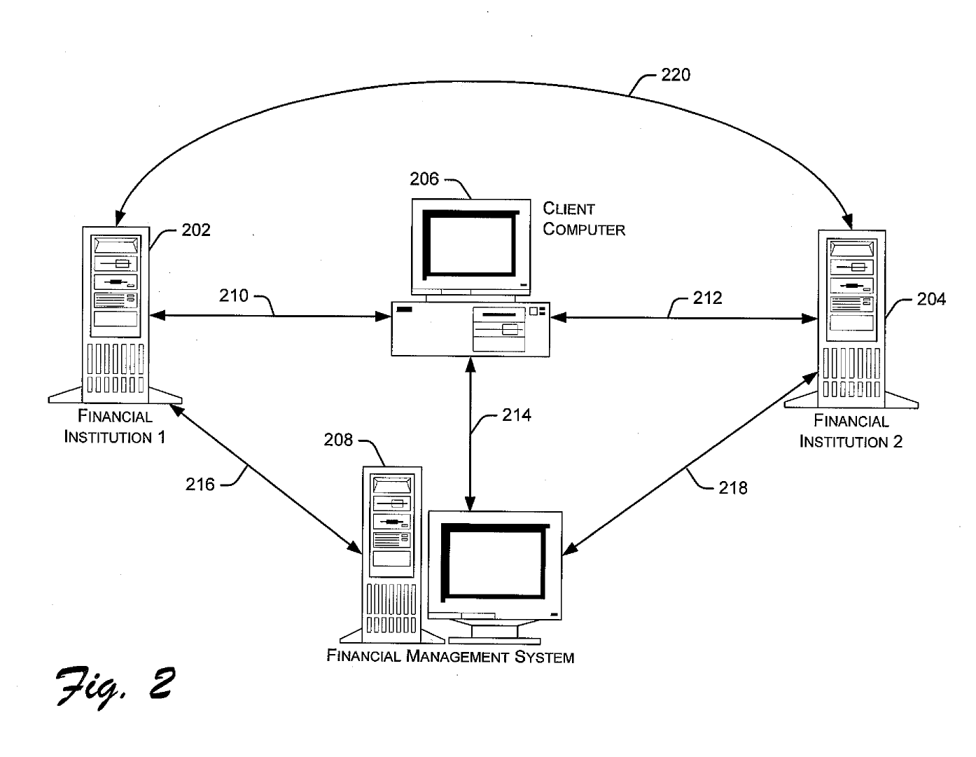

FIG. 2 illustrates an example of the interaction between a particular pair of financial institution servers 202 and 204, a client computer 206, and a financial management system 208. Client computer 206 is capable of accessing financial institution server 202 via a communication link 210 and accessing financial institution server 204 via a communication link 212. For example, the user of client computer 206 may retrieve account information or online banking fee information from one or both of the financial institution servers 202, 204. Client computer 206 is also capable of interacting with financial management system 208 via a communication link 214. The user of client computer 206 may access financial management system 208, for example, to have the system handle the transfer of automated bill payment services from the financial institution associated with server 202 to the financial institution associated with server 204.

Financial management system 208 is coupled to the two financial institution servers 202 and 204 via two communication links 216 and 218, respectively. Communication links 216 and 218 allow financial management system 208 to retrieve information from financial institution servers 202, 204, and perform functions on the financial institution servers on behalf of the user of client computer 206. Financial institution servers 202 and 204 are capable of communicating with one another via a communication link 220, which allows the servers to exchange data and other information with one another. Communication links 210-220 may be dial-up connections and/or connections via one or more networks of the type discussed above with respect to FIG. 1.

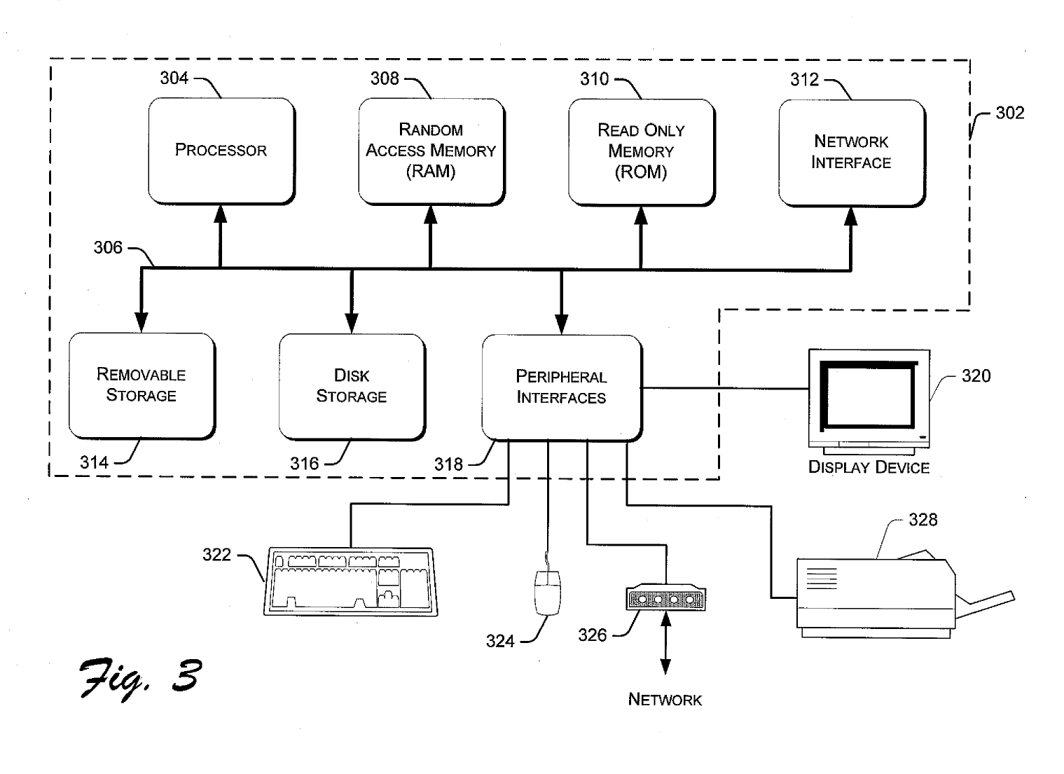

FIG. 3 is a block diagram showing pertinent components of a computer 302 in accordance with the invention. A computer such as that shown in FIG. 3 can be used, for example, to perform various operations such as handling the transfer of bill payment information between computing systems (e.g., servers) associated with different financial institutions. Computer 302 can also be used to access a web site or other computing facility to access the various functions. The computer shown in FIG. 3 can function as a server, a client computer, or a financial management system, of the types discussed herein.

Computer 302 includes at least one processor 304 coupled to a bus 306 that couples together various system components. Bus 306 represents one or more of any of several types of bus structures, such as a memory bus or memory controller, a peripheral bus, and a processor or local bus using any of a variety of bus architectures. A random access memory (RAM) 308 and a read only memory (ROM) 310 are coupled to bus 306. Additionally, a network interface 312 and a removable storage device 314, such as a floppy disk or a CD-ROM, are coupled to bus 306. Network interface 312 provides an interface to a data communication network such as a local area network (LAN) or a wide area network (WAN) for exchanging data with other computers and devices. A disk storage 316, such as a hard disk, is coupled to bus 306 and provides for the non-volatile storage of data (e.g., computer-readable instructions, data structures, program modules, and other data used by computer 302). Although computer 302 illustrates a removable storage 314 and a disk storage 316, it will be appreciated that other types of computer-readable media which can store data that is accessible by a computer, such as magnetic cassettes, flash memory cards, digital video disks, and the like, may also be used in the example computer.

Various peripheral interfaces 318 are coupled to bus 306 and provide an interface between the computer 302 and various individual peripheral devices. Example peripheral devices include a display device 320, a keyboard 322, a mouse 324, a modem 326, and a printer 328. Modem 326 can be used to access other computer systems and devices directly or by connecting to a data communication network such as the Internet.

A variety of program modules can be stored on the disk storage 316, removable storage 314, RAM 308, or ROM 310, including an operating system, one or more application programs, and other program modules and program data. A user can enter commands and other information into computer 302 using the keyboard 322, mouse 324, or other input devices (not shown). Other input devices may include a microphone, joystick, game pad, scanner, satellite dish, or the like.

Computer 302 may operate in a network environment using logical connections to other remote computers. The remote computers may be personal computers, servers, routers, or peer devices. In a networked environment, some or all of the program modules executed by computer 302 may be retrieved from another computing device coupled to the network.

Typically, the computer 302 is programmed using instructions stored at different times in the various computer-readable media of the computer. Programs and operating systems are often distributed, for example, on floppy disks or CD-ROMs. The programs are installed from the distribution media into a storage device within the computer 302. When a program is executed, the program is at least partially loaded into the computer's primary electronic memory. As described herein, the invention includes these and other types of computer-readable media when the media contains instructions or programs for implementing the steps described below in conjunction with a processor. The invention also includes the computer itself when programmed according to the procedures and techniques described herein.

For purposes of illustration, programs and other executable program components are illustrated herein as discrete blocks, although it is understood that such programs and components reside at various times in different storage components of the computer, and are executed by the computer's processor. Alternatively, the systems and procedures described herein can be implemented in hardware or a combination of hardware, software, and/or firmware. For example, one or more application specific integrated circuits (ASICs) can be programmed to carry out the systems and procedures described herein.

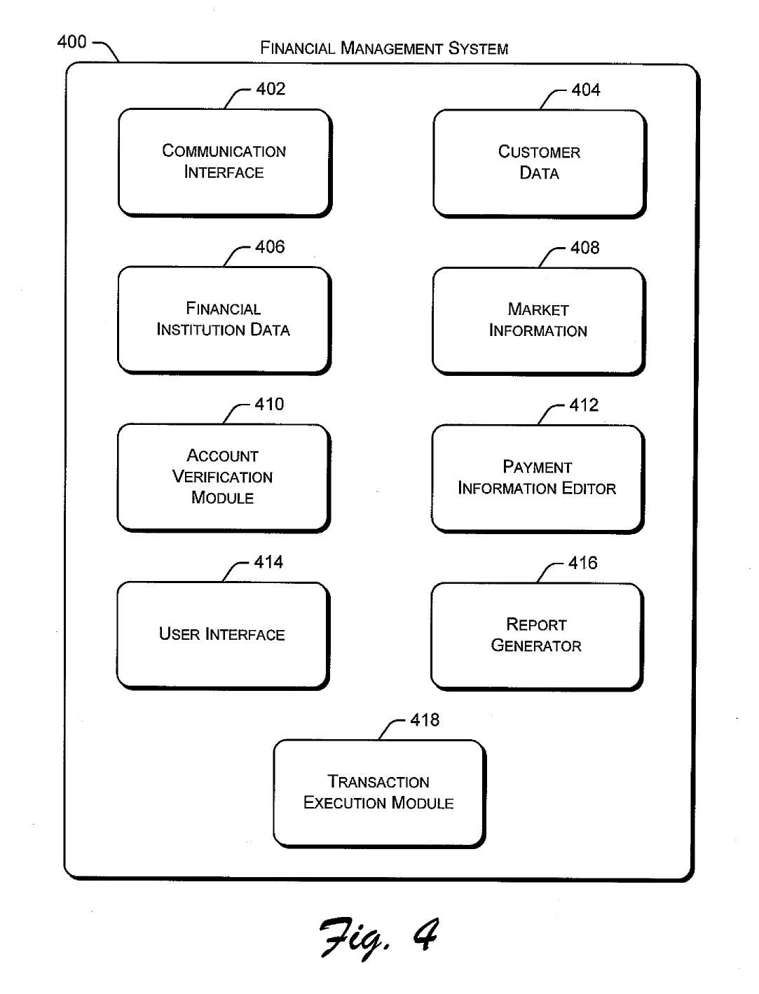

FIG. 4 is a block diagram showing example components and modules of a financial management system 400. A communication interface 402 allows financial management system 400 to communicate with other computing systems, such as servers, client computers, and portable computing devices. In one embodiment, communication interface 402 is a network interface to a LAN, which is coupled to another data communication network, such as the Internet.

Financial management system 400 stores customer data 404, such as customer account information, online banking login name and password, and user preferences. Financial management system 400 also stores financial institution data 406 and market information 408. Financial institution data 406 includes, for example, transaction routing data, account offerings, account interest rates, fees for various services, and minimum account balances. Market information 408 includes data such as average interest rates for different types of accounts (both asset accounts and debt accounts), the best available interest rates for each type of account, and average service fees charged by financial institutions.

An account verification module 410 authenticates information provided by a customer regarding one or more accounts, and verifies that the customer has the proper credentials to access one or more accounts. A payment information editor 412 allows a customer to edit automated payment information and/or online bill payment information associated with accounts at one or more financial institutions. For example, the customer may edit the payment amount, payment date, payee information, and the like. A user interface 414 allows a customer to interact with financial management system 400. In a particular embodiment, user interface 414 is a graphical user interface.

A report generator 416 generates various types of reports, such as account activity history, a report comparing service fees at different financial institutions, and a summary of bill payment information transferred between two financial institutions. A transaction execution module 418 executes various financial transactions, such as the transfer of funds between financial institutions or the transfer of bill payment information between two financial institutions. For example, an account holder may request that financial management system 400 handle the transfer of online bill payment information from a current financial institution to a new account at a new financial institution. In this example, financial management system 400 performs the requested transfer by following the operations discussed herein.

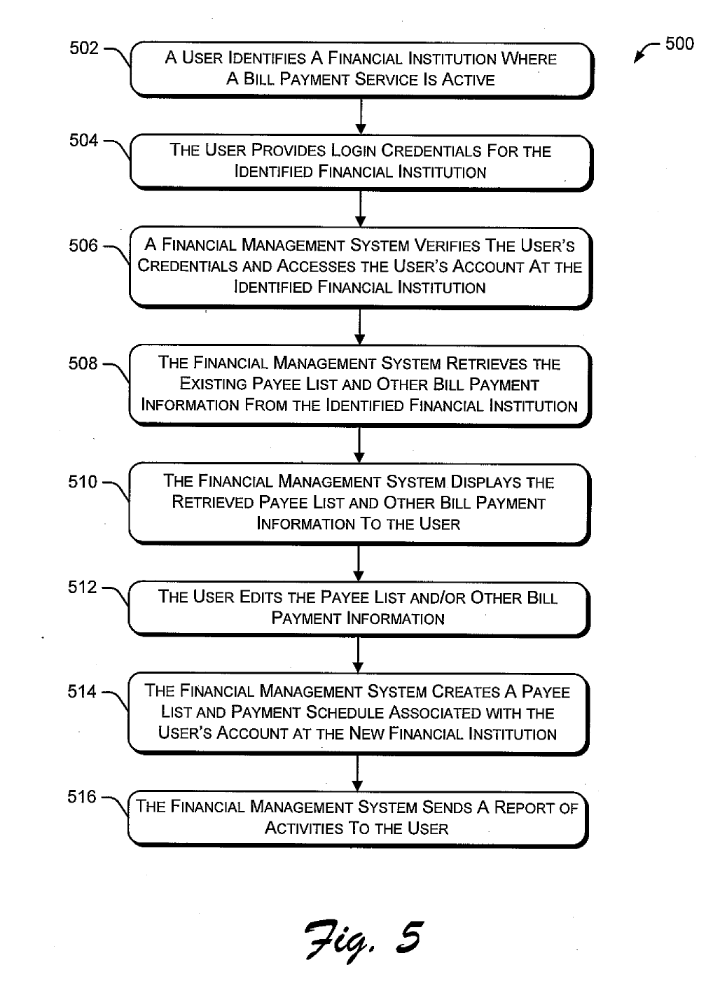

FIG. 5 is a flow diagram illustrating an example procedure 500 for transferring bill payment information from a first financial institution to a second financial institution. Initially, a user identifies a financial institution where a bill payment service is active (block 502). The bill payment service may be an automated bill payment service, an online bill payment service, or any other type of service. The user provides login credentials for the identified financial institution (block 504). Login credentials include, for example, a user name and an associated password used to access the user's account at the identified financial institution. A financial management system verifies the user's credentials and accesses the user's account at the identified financial institution (block 506). For example, the financial management system accesses the user's account with the user name and password provided by the user. If the financial management system is able to access the user's account, then the login credentials are verified.

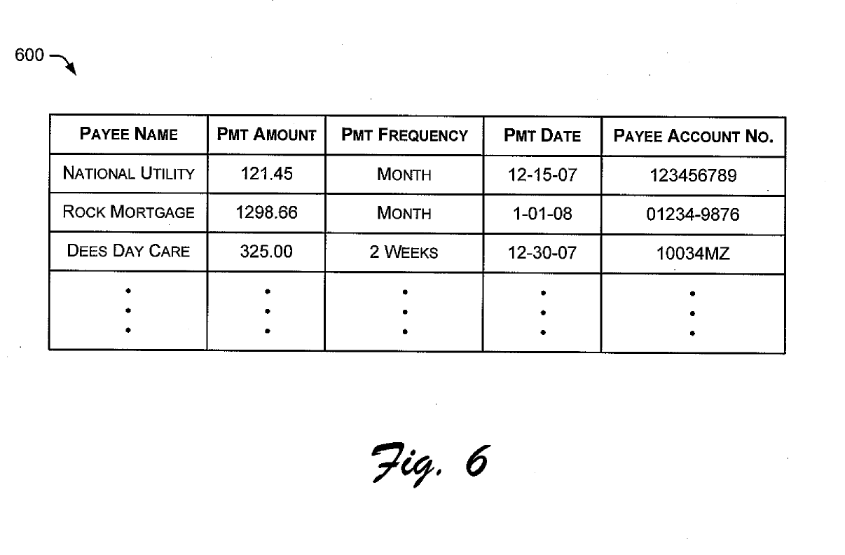

Procedure 500 continues as the financial management system retrieves the existing payee list and other bill payment information from the identified financial institution (block 508). The retrieved information includes, for example, payee name, payment amount, payment date, payee account number, payee address, payee phone number, payment frequency, and the like. Next, the financial management system displays the retrieved payee list and other bill payment information to the user (block 510). FIG. 6 illustrates an example display 600 of the retrieved payee list and other bill payment information. Alternate displays may include additional information not shown in FIG. 6 and/or may delete some of the information shown in FIG. 6. A particular display of information may contain any number of entries associated with any number of payees.

The procedure continues by optionally allowing the user to edit the payee list and/or other bill payment information displayed to the user (block 512). For example, the user may change the payment amount, payment date, or any other bill payment information displayed to the user. Further, the user may delete information, such as all information associated with a particular payee. The user may also add bill payment information associated with one or more new payees. In one embodiment, the user is presented with a check box adjacent each payee displayed. The user activates the check box to indicate that the payee bill payment information associated with that check box should be transferred to the new financial institution. Bill payment information associated with a non-activated check box is not transferred to the new financial institution. Bill payment information that is not transferred to the new financial institution may remain active on the first financial institution or may be deactivated (or deleted) on the first financial institution.

The procedure continues as the financial management system creates a payee list and a payment schedule associated with the user's account at the new financial institution (block 514). The financial management system also stores other bill payment information associated with the user's account at the new financial institution. The various information may be stored on the financial management system or on one or more servers (or other devices) associated with the new financial institution. The financial management system then sends a report to the user (block 516) describing the bill payment information transferred to the new financial institution. The report may also indicate any changes to the bill payment information as well as any payees deleted from or added to the bill payment information.

After the bill payment information has been transferred from the first financial institution to the second financial institution, the bill payment information stored on the first financial institution may be deleted or deactivated. This is necessary to prevent duplicate bill payments (e.g., both the first financial institution and the second financial institution paying the same bill).

Various techniques may be used to retrieve data from financial institutions. In one embodiment, the financial management system maintains information regarding various financial institutions. That information is used to locate and communicate with various financial institution servers. Additionally, a variety of data harvesting scripts also maintained by the financial management system. For example, a separate data harvesting script may be maintained for each financial institution from which data is extracted. Data harvesting (also referred to as “screen scraping”) is a process that allows, for example, an automated script to retrieve data from one or more web pages associated with a web site. Data harvesting may also include retrieving data from a data source using any data acquisition or data retrieval procedure.

Data may also be retrieved from sources other than web pages. For example, data can be retrieved from a source that supports the Open Financial Exchange (OFX) specification or the Quicken Interchange Format (QIF). OFX is a specification for the electronic exchange of financial data between financial institutions, businesses, and consumers via the Internet. OFX supports a wide range of financial activities including consumer and business banking, consumer and business bill payment, bill presentment, and investment tracking, including stocks, bonds, mutual funds, and 401(k) account details. QIF is a specially formatted text file that allows a user to transfer Quicken transactions from one Quicken account register into another Quicken account register or to transfer Quicken transactions to or from another application that supports the QIF format.

Although the description above uses language that is specific to structural features and/or methodological acts, it is to be understood that the invention defined in the appended claims is not limited to the specific features or acts described. Rather, the specific features and acts are disclosed as example forms of implementing the invention.

1. A method comprising:
receiving a request to transfer bill payment data from a first account associated with a first entity to a second account associated with a second entity;
retrieving the bill payment data from the first entity; and
establishing the bill payment data at the second entity.

2. A method as recited in claim 1 further comprising allowing a user to modify the bill payment data prior to accessing the second account.

3. A method as recited in claim 1 further comprising deactivating the bill payment data associated with the first entity.

4. A method as recited in claim 1 further comprising deleting the bill payment data associated with the first entity.

5. A method as recited in claim 1 wherein the first entity and the second entity are financial institutions.

6. A method as recited in claim 1 further comprising accessing the second account.

7. A method as recited in claim 1 wherein the bill payment data includes payee and payment data.

8. A method as recited in claim 1 wherein the bill payment data includes automatic bill payment information.

9. A method as recited in claim 1 wherein the request is received from an account holder associated with the first account and the second account.

10. A method as recited in claim 1 wherein the bill payment data is related to an automated bill payment service.

11. A method as recited in claim 1 wherein the bill payment data is related to an online bill payment service.

12. A method as recited in claim 1 further comprising verifying a requestor's credentials associated with the first account.

13. A method of transferring financial information between financial institutions, the method comprising:
accessing a first account at a first financial institution;
retrieving bill payment information from the first account;
accessing a second account at a second financial institution; and
establishing bill payment activities associated with the second account based on the bill payment information retrieved from the first account.

14. A method as recited in claim 13 wherein accessing a first account at a first financial institution includes applying an account holder's credentials to gain access to the first account.

15. A method as recited in claim 13 further comprising editing the bill payment information prior to accessing the second account at the second financial institution.

16. A method as recited in claim 13 further comprising deactivating the bill payment information at the first financial institution.

17. A method as recited in claim 13 wherein the bill payment information includes at least one of payee data, payment data, or automatic bill payment information.

18. One or more computer-readable memories containing a computer program that is executable by a processor to perform the method recited in claim 13.

19. One or more computer-readable media having stored thereon a computer program that, when executed by one or more processors, causes the one or more processors to:
access a first account at a first financial institution;
retrieve bill payment information associated with the first account;
access a second account at a second financial institution;
establish bill payment activities associated with the second account based on the bill payment information retrieved from the first account; and
delete the bill payment information from the first financial institution.

20. One or more computer-readable media as recited in claim 19 wherein the one or more processors further allow a user to modify the bill payment information prior to accessing the second account.
